(19) United States
(12) Patent Application Publication
(10) Pub. No.: US 2007/0217438 A1
(43) Pub. Date: Sep. 20, 2007

(54) Ring node device and method of connecting terminal to ring node device

(75) Inventors: Masanori Kondo, Kawasaki (JP); Toshihiro Ban, Kawasaki (JP); Takashi Fukagawa, Kawasaki (JP); Kazuhiro Minamimoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/495,549

(22) Filed: Jul. 31, 2006

(30) Foreign Application Priority Data
Mar. 17, 2006 (JP) 2006-075293

(51) Int. Cl. H04L 12/28

(52) U.S. Cl. 370/404

(57) ABSTRACT

A ring node device includes a main Resilient Packet Ring (RPR) card and a queued RPR card. Upon detection of disconnection of a communication link between the main RPR card and an L2/L3 switch, the ring node device exercises control to switch from the main RPR card to the queued RPR card and carries out communication with the L2/L3 switch.

### BACKGROUND OF THE INVENTION

1. Field of the Invention

The present invention generally relates to a ring node device in a ring network and specifically relates to connecting a terminal to the ring node device.

2. Description of the Related Art

In network connections, such as in the Internet, it is preferable that wiring that connects internal nodes of a service provider or backbone wiring that connects service providers to each other satisfies the following requirements:

(A) able to deal with enhancement of communication speed,

(B) able to deal with increasing number of connections,

(C) able to deal with increase in amount of data, and

(D) have high reliability and an ability to recover after failure.

Conventionally, an optical fiber based high speed digital communication method called Synchronous Optical Network/Synchronous Digital Hierarchy (SONET/SDH) is used in the backbone wiring. In the SONET/SDH, the requirement (A) is satisfied by forming a ring type network of optical fibers. Moreover, the requirement (D) is satisfied by arranging dual rings and generally using one ring and using the other ring when failure in the one ring. However, because the other ring is used only occasionally, the SONET/SDH uses only half the physical band of the network, which makes it inefficient.

For satisfying the requirements (B) and (C), a technology of a Resilient Packet Ring (RPR) based on the SONET/SDH is disclosed in Japanese Patent Laid-Open Publication No 2001-36557. In the RPR, a duel ring is arranged and data is fed simultaneously in opposite directions to each of the dual rings. Such a configuration enables not only efficiently use the entire physical band, but also ensures high reliability and failure recovery of the same level as in the SONET/SDH.

However, in the conventional technology represented in Japanese Patent Laid-Open Publication No 2001-36557, there is no provision to take care of a failure in a transmission path between the ring node and a terminal that is connected under the ring node. In other words, if a failure occurs in the transmission path from an RPR interface card, which is provided in the RPR ring node for connecting the terminal, to the terminal, the terminal is cut off from the RPR ring, and the communication between the RPR ring node and the terminal gets terminated.

One approach could be to include dual RPR interface cards in a ring node and ensure dual transmission paths between the RPR interface and the terminal, so that even if one transmission path is disconnected, communication can be continued using the other transmission path.

However, according to the recommendations of IEEE802.17 that regulates RPR specifications, if dual RPR cards are arranged, then the terminals connected to each of the duel RPR cards must be allocated different Media Access Control (MAC) addresses. Thus, for switching from a main RPR card to the other queued RPR card, unless a MAC address entry related to a portion affected by the failure is deleted, the terminal is disconnected from the network after an aging period of several minutes, and the switching cannot be carried out smoothly.

In IEEE802.17, a flush frame is included, as a means for controlling, in an Operation Administration Maintenance (OAM). However, although the flush frame deletes a frame in a priority control queue, the flush frame does not delete the MAC address entry related to the portion affected by the failure.

### SUMMARY OF THE INVENTION

It is an object of the present invention to at least partially solve the problems in the conventional technology.

According to an aspect of the present invention, a ring node device included in a ring network, the ring node device allocated with an identifier for identifying the ring node device from other devices on the ring network includes a first connecting unit and a second connecting unit, the first connecting unit and the second connecting unit employing Resilient Packet Ring (RPR) technique, the first connecting unit and the second connecting unit being allocated with same identifier as that of the ring node device, the first connecting unit and the second connecting unit being input with a first signal from the ring network for sending the first signal to a terminal and input with a second signal from the terminal for sending the second signal to the ring network; a second controlling unit that controls the second connecting unit so that the second connecting unit does not output the first signal to the terminal; and a second masking unit that masks the second signal before the second signal is input into the second connecting unit.

According to another aspect of the present invention, a method of connecting a terminal device to a ring node device included in a ring network, the ring node device allocated with an identifier for identifying the ring node device from other devices on the ring network, the ring node device including a first connecting unit and a second connecting unit, the first connecting unit and the second connecting employing Resilient Packet Ring (RPR) technique, the first connecting unit and the second connecting unit being allocated with the same identifier as that of the ring node device, the method including inputting a first signal received via the ring network to both the first connecting unit and the second connecting unit for sending the first signal to the terminal; controlling the second connecting unit so that the first signal is not output to the terminal; masking a second signal received from the terminal before the second signal is input into the second connecting unit; and outputting the second signal output from any one of the first connecting unit and the second connecting unit to the ring network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the drawback of a conventional Resilient Packet Ring (RPR) connecting method;

FIG. 2 is a schematic for explaining the concept and salient features of an RPR connecting method according to an embodiment of the present invention;

FIG. 3 is a functional block diagram for explaining the concept of an RPR card redundant structure;

FIG. 4 is a functional block diagram of the structure of a station shown in FIG. 3;

FIG. 5 is a diagram for explaining an operation of the RPR card redundant structure in an initial state;

FIG. 6 is a diagram for explaining an egress operation of the RPR card redundant structure;

FIG. 7 is a diagram for explaining an ingress operation of the RPR card redundant structure;

FIG. 8 is a functional block diagram for explaining the operation performed by the RPR card redundant structure at the time of occurrence of a failure;

FIG. 9 is a diagram for explaining the operation performed by the RPR card redundant structure at the time of occurrence of the failure; and

FIG. 10 is a diagram for explaining the operation performed by the RPR card redundant structure once the failure has occurred.

### DETAILED DESCRIPTION OF THE PREFERRED EMBODIMENTS

Exemplary embodiments of the present invention are explained in detail with reference to the accompanying drawings. The present invention is not limited to the embodiments explained below.

The present invention is applied to a ring node device for connecting terminals to a Resilient Packet Ring (RPR) ring network based on a Synchronous Optical Network/Synchronous Digital Hierarchy (SONET/SDH).

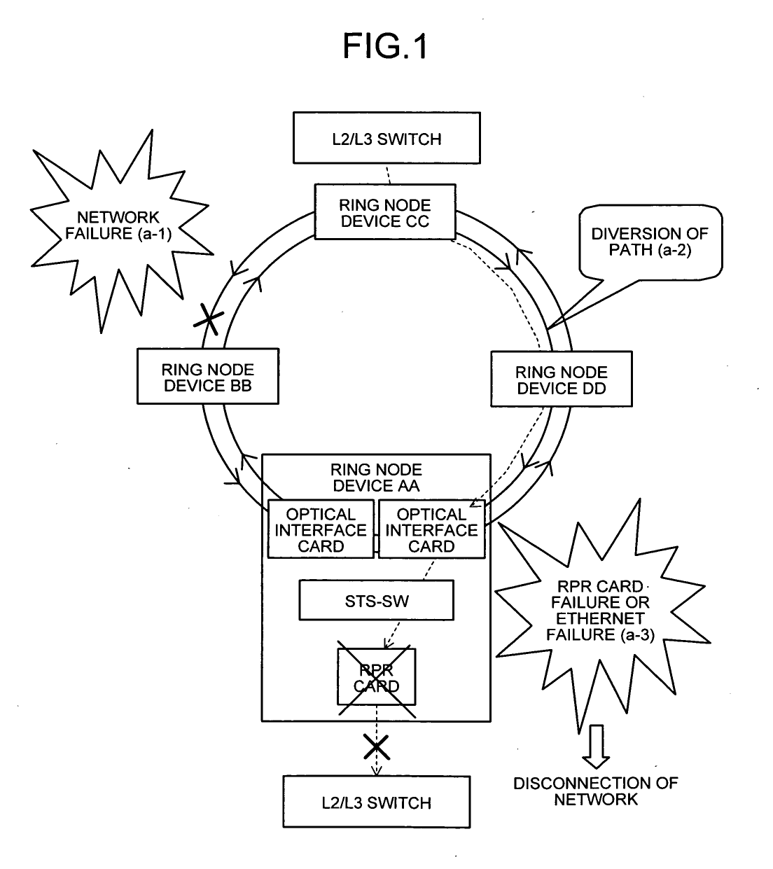

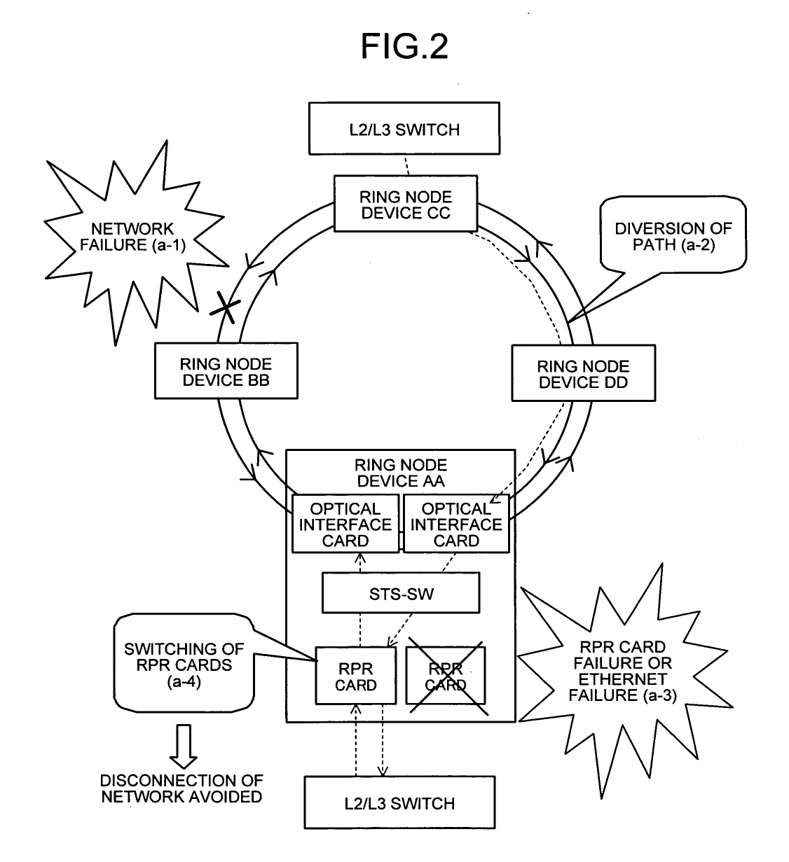

FIG. 1 is a schematic for explaining the drawback of the conventional RPR connecting method. On the other hand, FIG. 2 is a schematic for explaining the concept and the salient features of an RPR connecting method according to an embodiment of the present invention. A network to which the RPR connecting method is applied includes ring node devices AA to DD and duel paths that connect the ring node devices to each other. A terminal (not shown) is connected under each of the ring node devices AA through DD via an L2 switch or an L3 switch (hereinafter, “L2/L3 switch”). It is assumed here that signals are transmitted from the ring node device CC to the ring node device AA, and that a network failure has occurred on a transmission path between the ring node device CC and the ring node device BB.

In the conventional RPR connecting method, when the network failure occurs (network failure (a-1)), steering, which is a ring protection function, changes the transmission path of the signal so that the signal takes the transmission path from the ring node device CC to the ring node device AA via the ring node device DD (diversion of path (a-2)). Thus, the inconvenience arising due to the occurrence of network failure is avoided by using the techniques of steering or wrapping.

However, the L2/L3 switch is connected to an RPR card in a corresponding ring node device via Ethernet (registered trademark), and the RPR card can fail (hereinafter, “RPR card failure”) or the Ethernet can fail (hereinafter, “Ethernet failure”) (RPR card failure or Ethernet failure (a-3)). When an RPR card failure or Ethernet failure occurs, because no provision exists to take care of the failure, the connection between the RPR card and the L2/L3 switch is disconnected (disconnection of network).

In the present embodiment, two RPR cards are arranged in each ring node device and a L2/L3 switch corresponding to the ring node device is Ethernet connected to both the RPR cards. If an RPR card failure or Ethernet failure (a-3) occurs in one transmission path, transmission is switched to other transmission path that is operating normally (switching of path (a-4)), and communication between the RPR node device and the L2/L3 switch is continued via the new transmission path.

Thus, by including a redundant structure of the RPR cards and the transmission paths from the RPR cards to the L2/L3 switch inside the ring node device, failure recovery against a failure occurring in the RPR ring network or the ring node device is ensured without eliminating the significance of a failure recovery function in the RPR ring network itself.

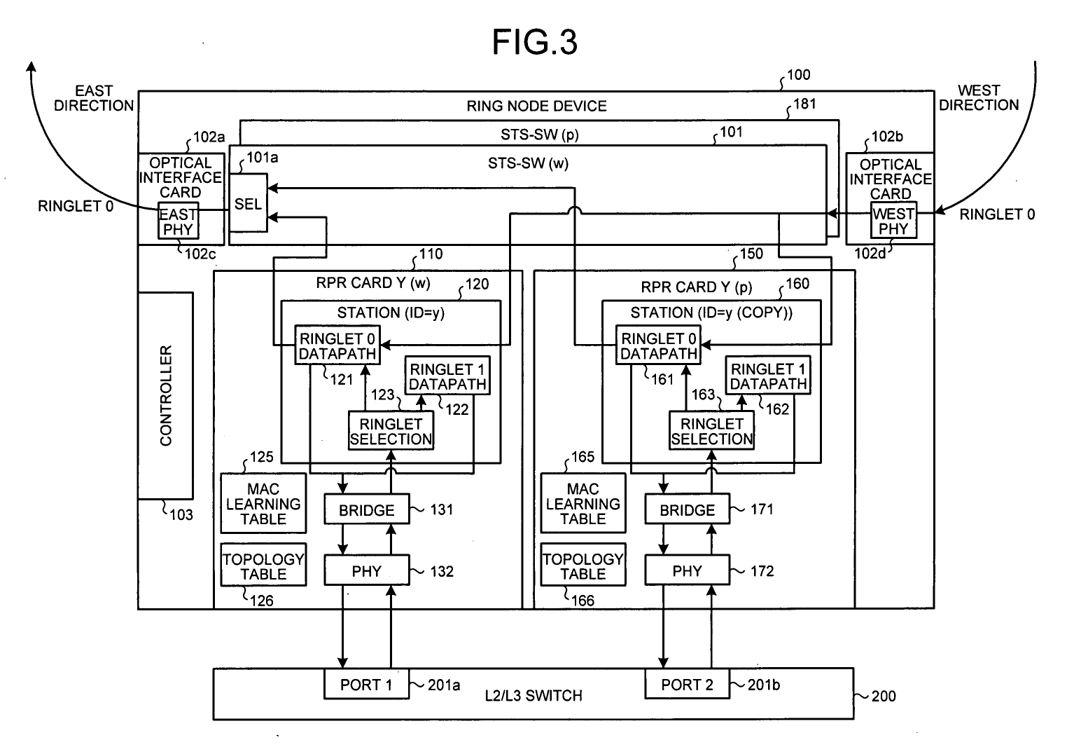

FIG. 3 is a functional block diagram for explaining the concept of the RPR card redundant structure. Only a transmission path Ringlet0 from West direction to East direction and a data communication path Ringlet0 Datapath of the Ringlet0 inside the ring node device are shown in FIG. 3. However, the ring node device similarly includes a transmission path Ringlet1 from East direction to West direction and a data communication path Ringlet1 Datapath of the Ringlet1 inside the ring node device.

Further, only an STS-SW (w) that inputs input signals from the Ringlet0 into an RPR card Y (w) and an RPR card Y (p) and selectively transmits output signals from the RPR card Y (w) and the RPR card Y (p) to the Ringlet0 inside the ring node device is shown in FIG. 3. However, the ring node device similarly includes an STS-SW (p) that inputs input signals from the Ringlet1 into the RPR card Y (w) and the RPR card Y (p) and selectively transmits output signals from the RPR card Y (w) and the RPR card Y (p) to the Ringlet1 inside the ring node device.

Because “w” of the “RPR card Y (w)” indicates “Working”, in other words, “Operation”, the “RPR card Y (w)” is a main (selecting) RPR card in operation. Because “p” of the “RPR card Y (p)” indicates “Protection”, the “RPR card Y (p)” is a queued RPR card that is waiting. “STS-SW” which indicates “Synchronous Transport Signal Switch” is a card that carries out cross connection of paths in the SONET/SDH (modifies edge to edge paths). The STS-SW selects the RPR card Y (w) or the RPR card Y (p) as a path using SEL that is explained later. Further, “w” and “p” of “STS-SW (w)” and “STS-SW (p)” respectively indicate similar meanings as “RPR card Y (w)” and “RPR card Y (p)” respectively.

As shown in FIG. 3, a ring node device 100 includes an STS-SW (w) 101, an STS-SW (p) 181, an optical interface card 102a that is an interface to transmit signals from the STS-SW (w) 101 or the STS-SW (p) 181 to the Ringlet0, an optical interface card 102b that is an interface to input the input signals from the Ringlet0 into the STS-SW (w) 101 or the STS-SW (p) 181, a main RPR card Y (w) 110, a queued RPR card Y (p) 150, and a controller 103 that controls the entire ring node device 100. The optical interface card 102a includes a physical interface East PHY 102c for transmitting signals to East direction of the Ringlet0, and the optical interface card 102b includes a physical interface West PHY 102d for receiving the signals from West direction of the Ringlet0.

The STS-SW (w) 101 includes a selector SEL (abbreviation of selection) 101a that selects either transmission signals from the RPR card Y (w) 110 to the Ringlet0 or transmission signals from the RPR card Y (p) 150 to the Ringlet0 and distributes the selected transmission signals to the East PHY 102c that is explained later. The STS-SW (p) 181 also includes a structure that is similar to the structure of the STS-SW (w) 101. The structure of the STS-SW (p) 181 is not shown in FIG. 3.

The RPR card Y (w) 110 includes a station (ID=y) 120 having a station ID “y”, a MAC learning table 125, a topology table 126, a bridge 131 that exercises output termination control and mask control of signals that are output from the station (ID=y) 120 to an L2/L3 switch 200 that is explained later and signals that are input into the station (ID=y) 120 from the L2/L3 switch 200, and a physical interface PHY 132 that is an interface of transfer of signals between the RPR card Y (w) 110 and the L2/L3 switch 200.

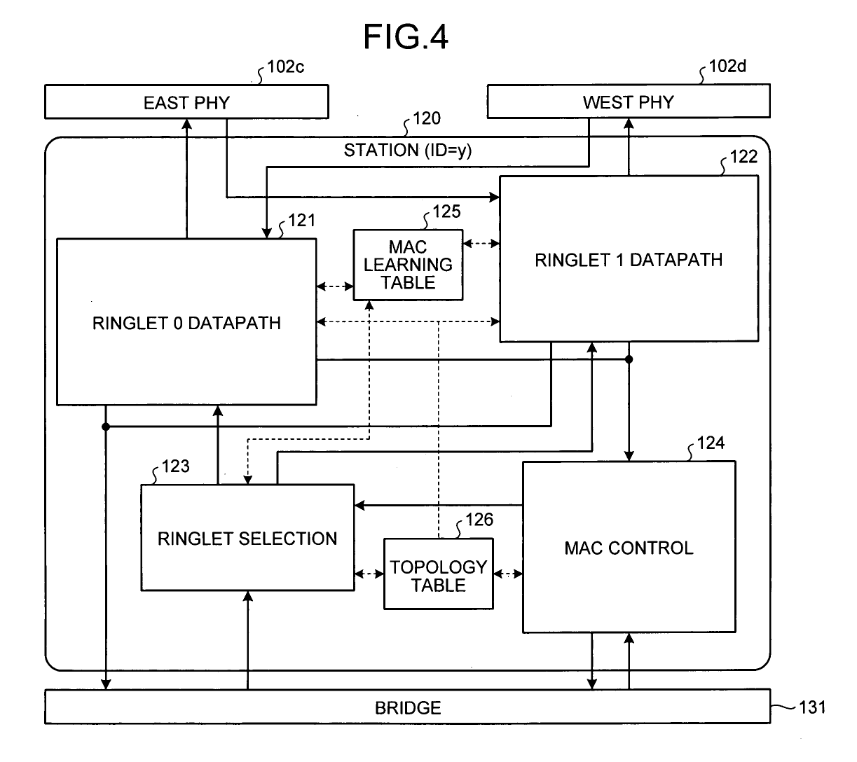

The station (ID=y) 120 includes a Ringlet0 Datapath 121 that is a connecting point of the RPR card Y (w) 110 and the Ringlet0, a Ringlet1 Datapath 122 that is a connecting point of the RPR card Y (w) 110 and the Ringlet1, and a Ringlet Selection 123 that distributes the signals from the L2/L3 switch 200 to the Ringlet0 Datapath 121 or the Ringlet1 Datapath 122 by switching. A detailed structure of the station (ID=y) 120 is explained with reference to FIG. 4.

Similarly as the RPR card Y (w) 110, the RPR card Y (p) 150 also includes a station (ID=y (copy)) 160 having a copied ID “y”, a MAC learning table 165, a topology table 166, a bridge 171 that exercises output termination control and mask control of signals that are output from the station (ID=y (copy)) 160 to the L2/L3 switch 200 and signals that are input into the station (ID=y (copy)) 160 from the L2/L3 switch 200, and a physical interface PHY 172 that is an interface of transfer of signals between the RPR card Y (p) 150 and the L2/L3 switch 200.

As shown in FIG. 3, because the RPR card Y (p) 150 is the queued RPR card, the bridge 171 terminates a signal output to the L2/L3 switch 200, and masks a signal input from the L2/L3 switch 200. In the aforementioned signal output termination and signal input masking, although a communication link is established between the RPR card Y (p) 150 and the L2/L3 switch 200, transceiving of frames is terminated to prevent learning of the MAC address.

When a failure occurs in the RPR card Y (w) 110 and the RPR card Y (p) 150 is substituted in operation, the bridge 171 starts a signal output to the L2/L3 switch 200 and unmasks the signal input from the L2/L3 switch 200. The bridge 131 of the RPR card Y (w) 110 terminates the signal output to the L2/L3 switch 200 and starts masking the signal input from the L2/L3 switch 200.

The SEL 101a selects the output signals from the RPR card Y (w) 110, and transmits the selected output signals to the Ringlet0 without selecting the output signals from the RPR card Y (p) 150. When a failure occurs in the RPR card Y (w) 110 and the RPR card Y (p) 150 is substituted in operation, the SEL 101a discontinues selection of the output signals from the RPR card Y (w) 110, selects the output signals from the RPR card Y (p) 150, and transmits the selected output signals to the Ringlet0.

The L2/L3 switch 200 for connecting the terminals to the RPR ring network (Ringlet0 and Ringlet1) via the ring node device 100 includes a Port1 201a and a Port2 201b. The Port1 201a is a connecting port for connecting the L2/L3 switch 200 and the RPR card Y (w) 110 via the physical interface PHY 132. The Port2 201b is a connecting port for connecting the L2/L3 switch 200 and the RPR card Y (p) 150 via the physical interface PHY 172.

The ring node device 100 includes the RPR card Y (w) 110 and the RPR card Y (p) 150. A redundant structure is included such that even during occurrence of a failure such as disconnection of the communication link between one of the RPR cards and the L2/L3 switch 200, the transmission path can be secured by switching to the other RPR card. Thus, the ring node device 100 is detachable as a maintenance unit, compatible with a conventional method, and enables a smooth switching from the main RPR interface card to the queued RPR interface card during occurrence of a failure, thereby enabling to prevent elimination of high failure recovery of the RPR ring network resulting from disconnection of the RPR ring network due to occurrence of the failure inside the ring node device.

FIG. 4 is a functional block diagram of the structure of the station (ID=y) 120. The station (ID=y (copy)) 160 of the RPR card Y (p) 150 has almost a similar structure as that of the station (ID=y) 120.

The station (ID=y) 120 includes the Ringlet0 Datapath 121 that receives signals from the West PHY 102d and outputs the signals to the East PHY 102c, the Ringlet1 Datapath 122 that receives signals from the East PHY 102c and outputs the signals to the West PHY 102d, the Ringlet Selection 123 that selects the Ringlet0 Datapath 121 or the Ringlet0 Datapath 122 and distributes the signals received from the bridge 131, a MAC control 124 that transfers the MAC address to the terminal that is connected to the L2/L3 switch 200 via the bridge 131, the MAC learning table 125 that stores the MAC address distributed between the Ringlet0 Datapath 121, the Ringlet1 Datapath 122, and the Ringlet Selection 123 and distributes data of the stored MAC address, and the topology table 126. The topology table 126 stores data which expresses in the form of the MAC address of the ring node device, the signal transmission path that is included in the RPR network and distributed between the Ringlet0 Datapath 121, the Ringlet1 Datapath 122, and the Ringlet Selection 123, and distributes data that expresses in the form of the MAC address of the ring node device, the stored signal transmission path. The station ID corresponds to the MAC address of the ring node device.

The Ringlet0 Datapath 121 carries out an encapsulation process to embed ether frame format data fetched from the Ringlet Selection 123 into payload of an RPR data frame format, and carries out a decapsulation process to extract ether frame format data from the payload of the RPR data frame format fetched from the Ringlet0 via the West PHY 102d.

Further, the Ringlet0 Datapath 121 carries out queuing of received data and shaping of transmission data. If the received RPR data frame needs to be transmitted to the terminal connected under the ring node device 100, the Ringlet0 Datapath 121 generates a copy of the received RPR data frame, carries out decapsulation, and transmits the RPR data frame to the bridge 131. If the received RPR data frame needs to be transferred to another ring node device instead of transmitting to the terminal connected under the ring node device 100, the Ringlet0 Datapath 121 carries out a transit process. If the received RPR data frame is neither to be transmitted to the terminal connected under the ring node device 100 nor to be transferred to another ring node device, the Ringlet0 Datapath 121 carries out a destruction process of the RPR data frame. The Ringlet0 Datapath 121 carries out a process to transmit the encapsulated RPR data frame to the Ringlet0 via the East PHY 102c.

Similarly as the Ringlet0 Datapath 121, the Ringlet1 Datapath 122 also carries out the encapsulation process to embed the ether frame format data fetched from the Ringlet Selection 123 into the payload of the RPR data frame format, and carries out the decapsulation process to extract the ether frame format data from the payload of the RPR data frame format fetched from the Ringlet1 via the East PHY 102c.

Further, the Ringlet1 Datapath 122 carries out queuing of received data and shaping of transmission data. If the received RPR data frame needs to be transmitted to the terminal connected under the ring node device 100, the Ringlet1 Datapath 122 generates a copy of the received RPR data frame, carries out decapsulation, and transmits the RPR data frame to the bridge 131. If the received RPR data frame needs to be transferred to another ring node device instead of transmitting to the terminal connected under the ring node device 100, the Ringlet1 Datapath 122 carries out the transit process. If the received RPR data frame is neither to be transmitted to the terminal connected under the ring node device 100 nor to be transferred to another ring node device, the Ringlet1 Datapath 122 carries out the destruction process of the RPR data frame. The Ringlet1 Datapath 122 carries out a process to transmit the encapsulated RPR data frame to the Ringlet1 via the West PHY 102d.

Based on the data of the signal transmission path stored in the topology table 126, the Ringlet Selection 123 carries out a process to select a Ringlet (Ringlet1 or Ringlet0) to which the signals are transmitted. The Ringlet Selection 123 refers to the MAC learning table 125, selects the MAC address of the destination terminal, and selects the terminal for flooding (broadcasting). Further, the Ringlet selection 123 selects either a basic frame format or an extended frame format for transmitting the signals using the RPR frame format.

The MAC control 124 includes a function that transceives between stations, a frame that controls various functions such as a fairness function that prevents band congestion between the stations and ensures fairness, a function to manage topology data, and an Operations Administration and Maintenance (OAM) function etc.

The MAC learning table 125 includes “MAC” that indicates the MAC address of the terminal, an identifier “VID” that identifies a Virtual Local Area Network (VLAN) that is virtually treated as a single LAN irrespective of the physical topology, and “Direction” that indicates either an ingress direction or an egress direction. ingress indicates a direction from the terminal device to the RPR ring network, and egress indicates a direction from the RPR ring network to the terminal device. The MAC learning table 125 stores the MAC address that is distributed between the Ringlet0 Datapath 121, the Ringlet1 Datapath 122, and the Ringlet Selection 123, and distributes data of the stored MAC address.

The topology table 126 is a database that is constructed based on data of topology control frames that are transmitted from each station inside the ring network periodically or during a change in the status of the stations or the ring network. The topology table 126 includes a function to control data of the signal transmission path. The topology table 126 includes ring data, station data of the station (ID=y) 120 itself, and station data of other stations. The ring data controls number of stations (“hop”), failure data (“status”), and other ring attributes. The station data of the station (ID=y) 120 itself controls the MAC address of the station (ID=y) 120, a switching method, a switching status, checksum data, fairness data etc. The station data of other stations controls the station data of other stations in a hop number sequence separately in the Ringlet0 and the Ringlet1.

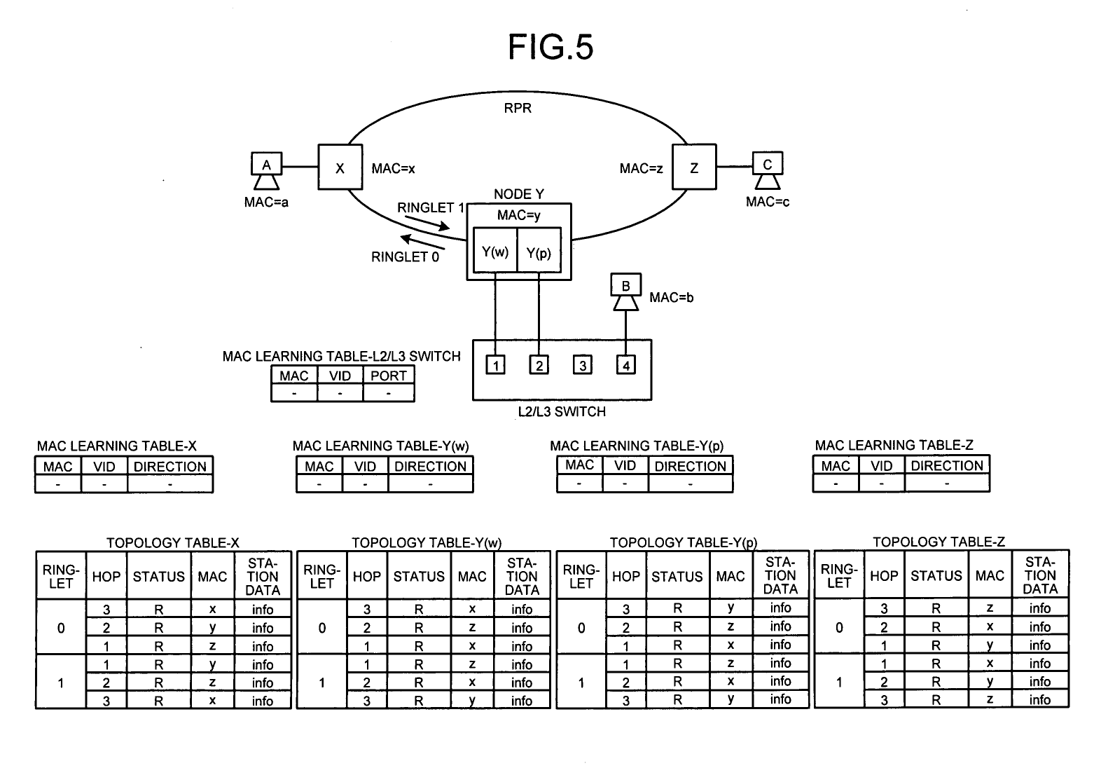

FIG. 5 is a diagram for explaining the operation of the initial status of the RPR card redundant structure shown in FIG. 3. As shown in FIG. 5, the RPR ring network includes a terminal A (MAC address=a) connected to a ring node device X (MAC address=x), a terminal B (MAC address=b) connected to a ring node device Y (MAC address=y), and a terminal C (MAC address=c) connected to a ring node device Z (MAC address=z).

The ring node device X (MAC address=x), the ring node device Y (MAC address=y), and the ring node device Z (MAC address=z) are redundant RPR ring node devices according to the present invention. Especially for the sake of convenience, the ring node device Y (MAC address=y) is assumed to include the RPR card Y (w) and the RPR card Y (p). The RPR card Y (w) and the RPR card Y (p) include the MAC address y as the same station ID. The RPR card Y (w) is connected to a Port1 of the L2/L3 switch, and the RPR card Y (p) is connected to a Port2 of the L2/L3 switch. The terminal B (MAC address=b) is connected to a Port4 of the L2/L3 switch.

In the initial status, a MAC learning table X included in the ring node device X does not store the MAC address, VID, and Direction (egress or ingress). A topology table X included in the ring node device X stores in the direction of the Ringlet0 as signal transmission path data, hop=1 that corresponds to MAC address=z, hop=2 that corresponds to MAC address=y, and hop=3 that corresponds to MAC address=x. Thus, the topology table X stores the station data included in each ring node device that corresponds to each MAC address. The number “hop” indicates a number of the ring node devices that are passed in the path. A value of “hop” is set in an initial value of ttl (Time to Live, in other words, a number of the ring node devices that are expected to be passed) of a header of an RPR extended data frame format that is explained later. The number of the ring node devices to be passed increases with an increase of the value in “hop”, thereby increasing the communication cost. “R” that corresponds to each hop indicates a status that is normal and reachable on the path. “I” indicates a status that is unreachable due to occurrence of a failure or switching control.

Similarly, the topology table X included in the ring node device X stores in the direction of the Ringlet1 as the signal transmission path data, hop=1 that corresponds to MAC address=y, hop=2 that corresponds to MAC address=z, and hop=3 that corresponds to MAC address=x. Thus, the topology table X stores the station data included in each ring node device that corresponds to each MAC address. “R” that corresponds to each hop indicates a status that is normal and reachable on the path.

A MAC learning table Y (w) and a MAC learning table Y (p) that are included respectively in the main RPR card Y (w) and the queued RPR card Y (p) included in the ring node device Y do not store the MAC address, VID, and Direction. A topology table Y (w) and a topology table Y (p) that are included respectively in the main RPR card Y (w) and the queued RPR card Y (p) included in the ring node device Y store in the direction of the Ringlet0 as the signal transmission path data, hop=1 that corresponds to MAC address=x, hop=2 that corresponds to MAC address=z, and hop=3 that corresponds to MAC address=y. Thus, the topology table Y (w) and the topology table Y (p) store the station data included in each ring node device that corresponds to each MAC address. “R” that corresponds to each hop indicates a status that is normal and reachable on the path.

Similarly, the topology table Y (w) and the topology table Y (p) that are included respectively in the main RPR card Y (w) and the queued RPR card Y (p) included in the ring node device Y store in the direction of the Ringlet1 as the signal transmission path data, hop=1 that corresponds to MAC address=z, hop=2 that corresponds to MAC address=x, and hop=3 that corresponds to MAC address=y. Thus, the topology table Y (w) and the topology table Y (p) store the station data included in each ring node device that corresponds to each MAC address. “R” that corresponds to each hop indicates a status that is normal and reachable on the path.

A MAC learning table Z that is included in the ring node device Z does not store the MAC address, VID, and Direction. A topology table Z included in the ring node device Z stores in the direction of the Ringlet0 as the signal transmission path data, hop=1 that corresponds to MAC address=y, hop=2 that corresponds to MAC address=x, and hop=3 that corresponds to MAC address=z. Thus, the topology table Z stores the station data included in each ring node device that corresponds to each MAC address. “R” that corresponds to each hop indicates a status that is normal and reachable on the path.

Similarly, the topology table Z included in the ring node device Z stores in the direction of the Ringlet1 as the signal transmission path data, hop=1 that corresponds to MAC address=x, hop=2 that corresponds to MAC address=y, and hop=3 that corresponds to MAC address=z. Thus, the topology table Z stores the station data included in each ring node device that corresponds to each MAC address. “R” that corresponds to each hop indicates a status that is normal and reachable on the path. A MAC learning table L2/L3 switch that is included in the L2/L3 switch also does not store the MAC address, VID, and Port. All the aforementioned topology tables of each connecting node are constructed based on the topology data in the control frames that are transceived periodically.

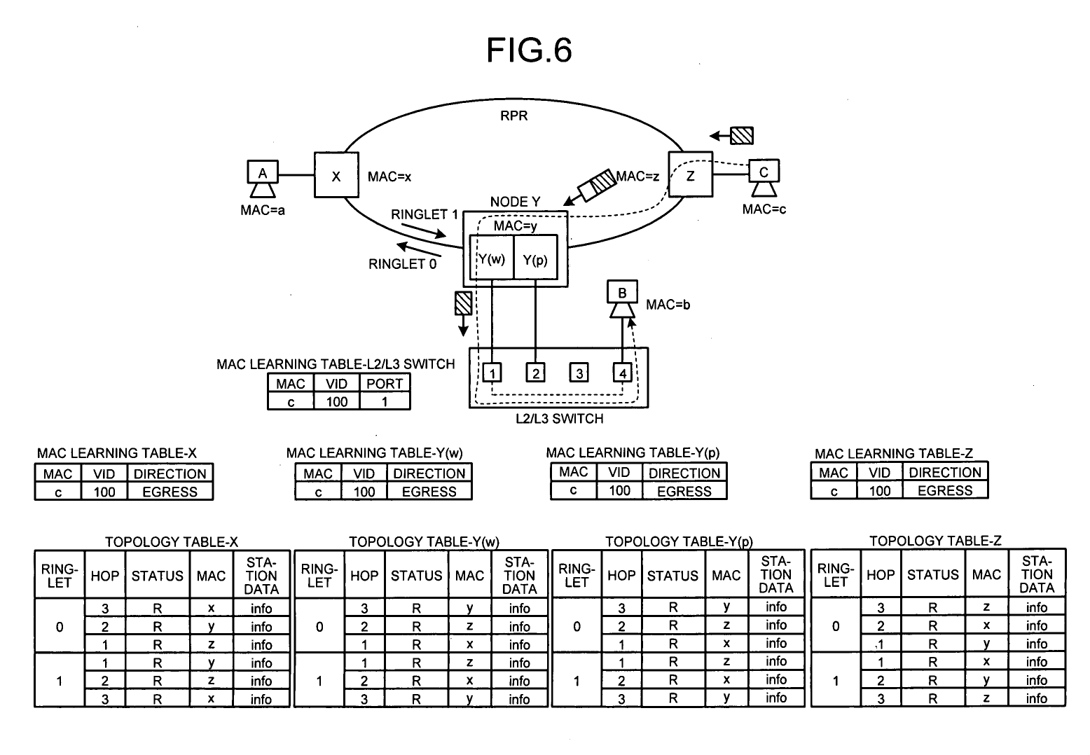

FIG. 6 is a diagram for explaining the egress operation of the RPR card redundant structure shown in FIG. 3. egress indicates a signal transmission direction from the RPR ring network to the terminal B. A structure of the network and the status of each topology table shown in FIG. 6 is the same as the structure of the network and the status of each topology table shown in FIG. 5. As shown in FIG. 6, ether frame format data is transmitted from the terminal C (MAC address=c) to the terminal B (MAC address=b).

The ether frame format data verifies that data of MAC address=b is not stored in the topology table Z of the ring node device Z, carries out RPR capsuling (extended frame format) and is encapsulated into RPR data frame format data. Next, the RPR data frame format data is flooded inside the ring network along with learning of MAC address=c. In other words, MAC address=c, VID=100, and Direction=ingress are stored in the MAC learning table Z. Any Ringlet can be selected and any flooding method can be used in the aforementioned operation.

The RPR data frame format data that is flooded inside the ring network is received by the ring node device X and the ring node device Y. MAC address=c, VID=100, and Direction=egress are stored in each MAC learning table. Based on flooding data included in the frame, the RPR data frame format data is also transmitted to each of the terminals under the ring node device X and the ring node device Y.

In the ring node device Y, the RPR data frame format data is transmitted to the terminal B via the RPR card Y (w). Because MAC address=b is still not learned by the L2/L3 switch, the RPR data frame format data is delivered to the terminal B by flooding. During delivery of the RPR data frame format data, the L2/L3 switch carries out learning of MAC address=c, VID=100, and Port=1. Before transmission of the RPR data frame format data to the terminal B, decapsulation of the RPR data frame format data is carried out in the RPR card Y (w), and ether frame format data is extracted from the payload of the RPR data frame format data.

Signals that are input from the Ringlet0 via the optical interface card are transmitted to the STS-SW via a SONET/SDH frame process. The STS-SW transmits the signals to both the RPR card Y (w) and the RPR card Y (p). The same RPR MAC process is executed in the stations of each RPR card. In the RPR MAC process, a destination MAC address and flooding data is extracted from the header of the RPR extended data frame format. The extracted MAC address is MAC address=b. Because the extracted MAC address differs from the MAC address=y of the RPR card Y (w) and the RPR card Y (p), the RPR data frame format data is passed (transited) in the direction of the Ringlet0 if a remaining number of the ring node devices exists in the ttl (Time to Live, in other words, a number of the ring node devices that are expected to be passed).

A copy of the RPR data frame format data is generated for distribution to the bridges, and the RPR data frame format data is decapsulated into the ether frame format data. During the decapsulation of the RPR data frame format data, a transmission source MAC address=c and Direction=egress are stored in the MAC learning table Y (w) and the MAC learning table Y (p).

Because signal output of the bridge of the queued RPR card Y (p) is terminated, the ether frame format data generated by decapsulation of the copied RPR data frame format data is subjected to a physical layer process only in the physical interface PHY of the main RPR card Y (w) and transmitted to the L2/L3 switch.

The SEL of the STS-SW transmits to the Ringlet0 only the RPR data frame format data that is transmitted from the main RPR card Y (w) among the RPR data frame format data that is passed (transited) in the direction of the Ringlet0.

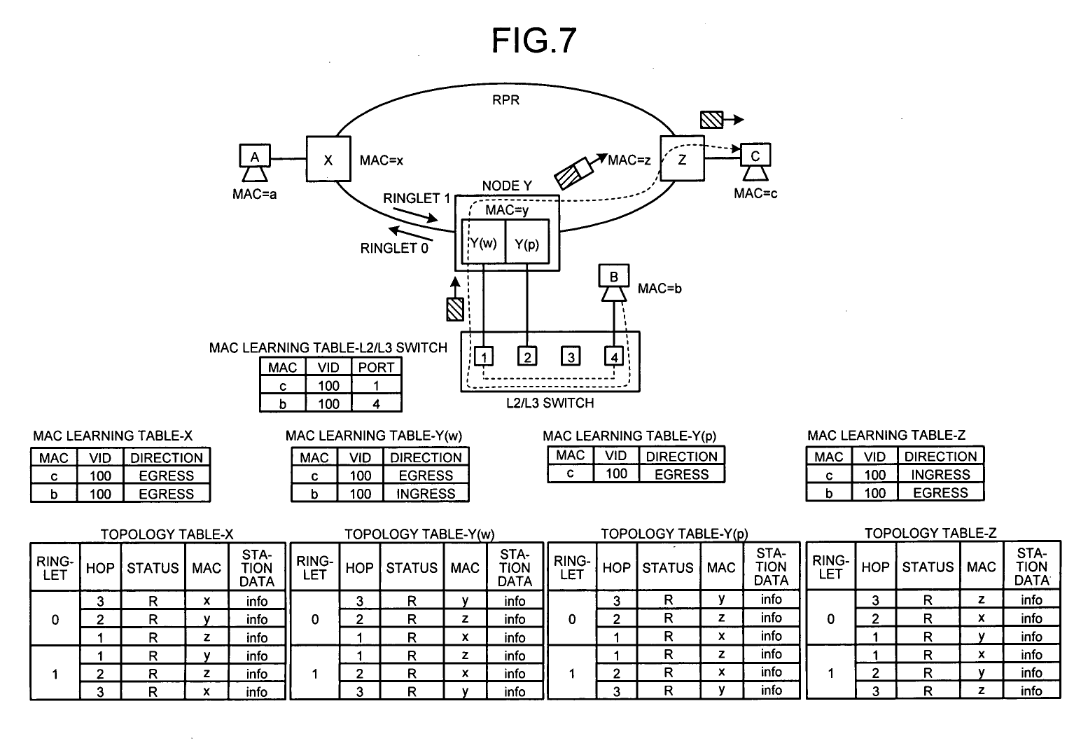

FIG. 7 is a diagram for explaining the ingress operation of the RPR card redundant structure shown in FIG. 3. Ingress indicates a signal transmission direction from the terminal B to the RPR ring network. A structure of the network and the status of each topology table shown in FIG. 7 is the same as the structure of the network and the status of each topology table shown in FIG. 5. The ingress operation after the egress operation shown in FIG. 6 is shown in FIG. 7. As shown in FIG. 7, the ether frame format data is transmitted from the terminal B (MAC address=b) to the terminal C (MAC address=c).

The ether frame format data transmitted from the terminal B to the terminal C searches data of MAC address=c that is stored in the MAC learning table-L2/L3 switch of the L2/L3 switch, and is transmitted from the Port1 to the RPR card Y (w). During transmission of the ether frame format data to the RPR card Y (w), the MAC learning table-L2/L3 switch further stores MAC address=b, VID=100, and Port=4. Because a path from the Port2 to the RPR card Y (p) is not stored in the MAC learning table-L2/L3 switch, the ether frame format data is not transmitted from the Port2 to the RPR card Y (p).

Based on a reference result of the topology table Y (w), the ether frame format data that is delivered from the Port1 to the RPR card Y (w) verifies that MAC address=c does not exist on the RPR ring network. Next, the ether frame format data is decapsulated into the RPR extended frame format data, and MAC address=b, VID=100, and Direction=ingress are stored in the MAC learning table Y (w). Next, the RPR extended frame format data is flooded inside the RPR ring network. Any Ringlet can be selected and any flooding method can be used in the aforementioned operation.

The ring node device X and the ring node device Y receive the RPR extended frame format data that is flooded inside the RPR ring network. MAC address=b, VID=100, and Direction=egress are stored in each MAC learning table. Based on the flooding data included in the frame of the RPR extended frame format data, the RPR extended frame format data is transmitted to each of the terminals under the ring node device X and the ring node device Y. In the ring node device Z, the RPR extended frame format data is decapsulated into the ether frame format data, and the ether frame format data is delivered to the destination terminal C.

The ether frame format data input from the Port1 is delivered to the stations of the RPR card Y (w) via the physical layer process in the physical interface PHY. Because the ether frame format data is input from the terminal, the flooding data is specified to an extended controller of the header of the RPR extended frame format data, thereby encapsulating the ether frame format data into the RPR extended frame format data, and the RPR extended frame format data is transmitted in the direction of the selected Ringlet. Any Ringlet can be selected and any flooding method can be used in the aforementioned operation.

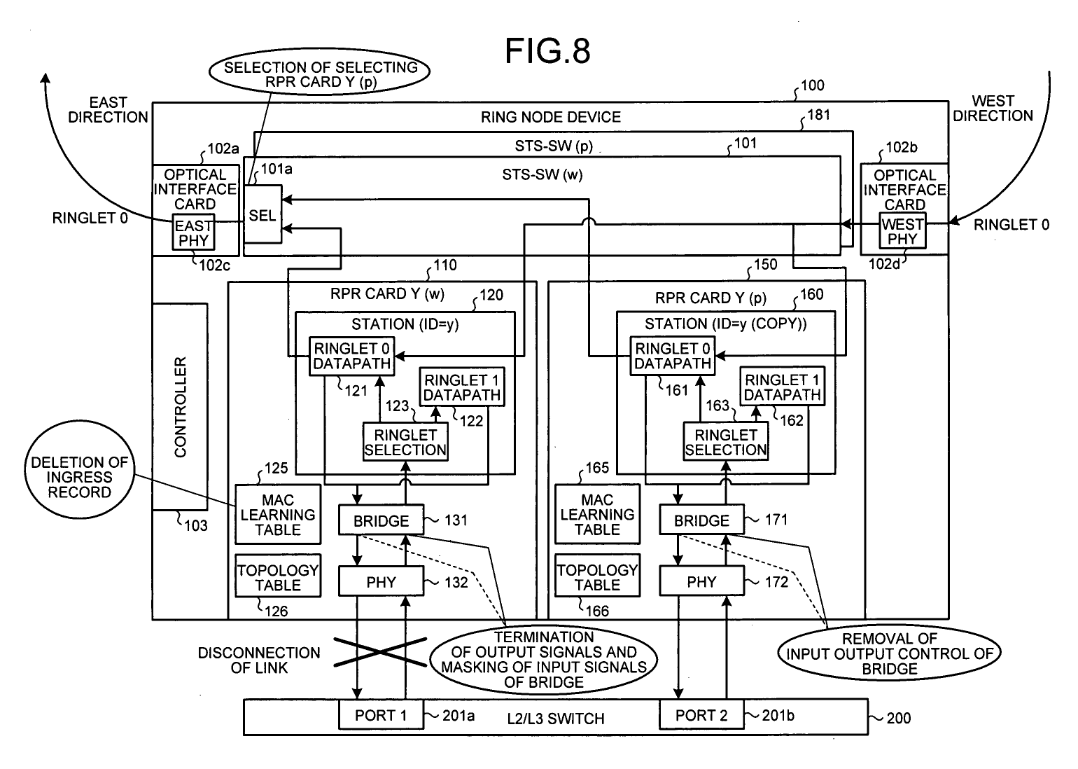

FIG. 8 is a functional block diagram for explaining the operation during occurrence of failure in the RPR card redundant structure shown in FIG. 3. Each functional block shown in FIG. 8 is the same as the respective functional block shown in FIG. 3.

A detection of disconnection of the communication link between the physical interface PHY 132 and the Port1 201a is shown in FIG. 8. Upon the detection of disconnection of the communication link between the physical interface PHY 132 and the Port1 201a, the bridge 131 of the RPR card Y (w) 110 starts termination of the output signals and masking of the input signals. Simultaneously, the bridge 171 of the RPR card Y (p) 150 starts output of signals and executes unmasking of the input signals. Due to this, the L2/L3 switch 200 can learn from the ether frame format data that is output from the RPR card Y (p) 150 and secure the transmission path. The aforementioned process enables distribution of the ether frame format data between the RPR card Y (p) 150 and the L2/L3 switch 200. All records of ingress in the MAC learning table 125 are deleted. Further, the SEL 101a of the STS-SW (w) 101 stops selection of output signals from the RPR card Y (w) 110, selects the output signals from the RPR card Y (p) 150, and transmits the selected output signals to the Ringlet0. Due to the detection of disconnection of the communication link between the RPR card Y (w) 110 and the Port1 201a of the L2/L3 switch 200, a record related to the Port1 201a is deleted from the MAC learning table-L2/L3 switch. Any amount of time can be set as a protection period from the detection of disconnection of the communication link until the unmasking of the input signals related to the Port2 201b.

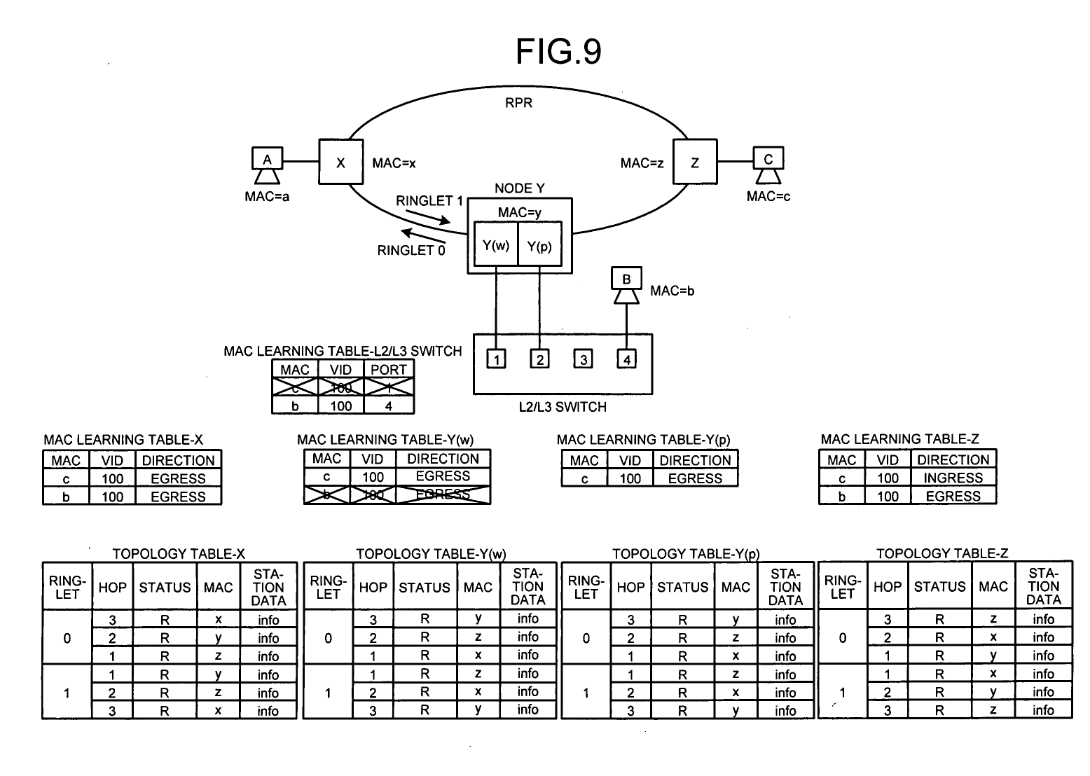

FIG. 9 is a diagram for explaining the operation during occurrence of failure in the RPR card redundant structure shown in FIG. 8. A structure of the network and the status of each topology table shown in FIG. 9 is the same as the structure of the network and the status of each topology table shown in FIG. 5.

During occurrence of a failure in the RPR card redundant structure, all records of ingress in the MAC learning table Y (w) are deleted, and upon detection of disconnection of the communication link between the RPR card Y (w) and the Port1, all records related to the Port1 are deleted from the MAC learning table-L2/L3 switch of the L2/L3 switch 200.

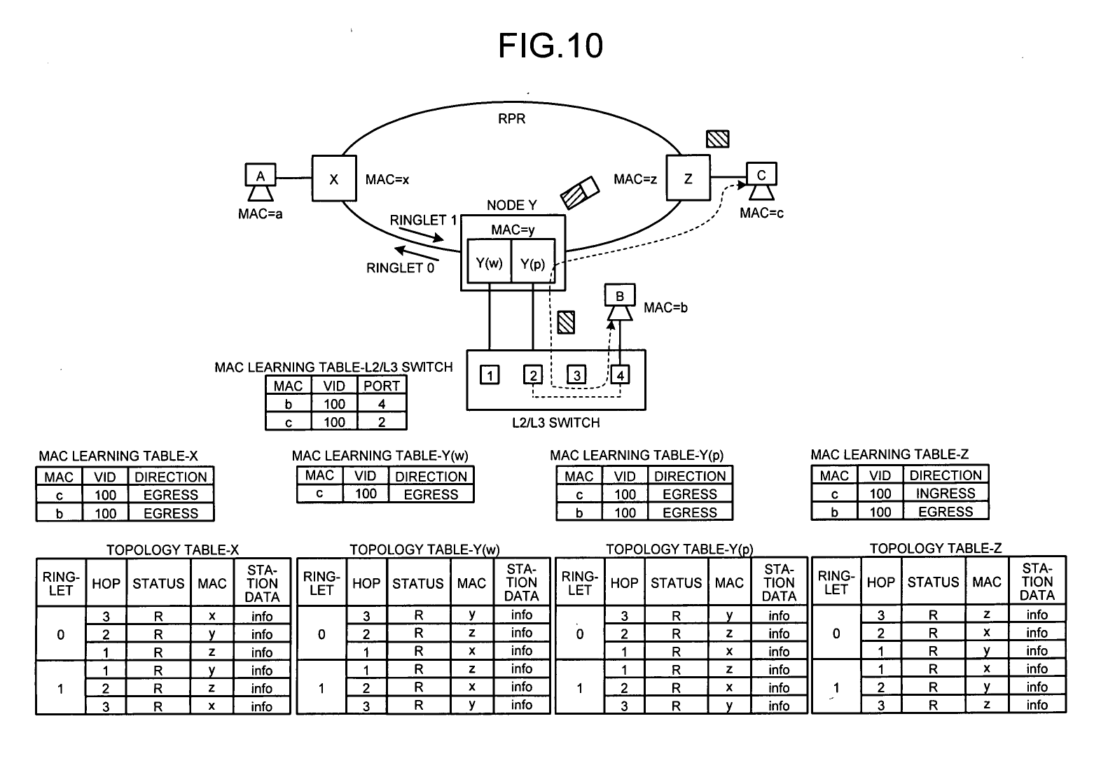

FIG. 10 is a diagram for explaining the operation after occurrence of a failure in the RPR card redundant structure shown in FIG. 8. A structure of the network and the status of each topology table shown in FIG. 10 is the same as the structure of the network and the status of each topology table shown in FIG. 5.

In the signal transmission from the terminal C to the terminal B, because a learning result of the path between the Port1 of the L2/L3 switch and the RPR card Y (w) is deleted from the MAC learning table L2/L3 switch, the RPR card Y (p) transmits the ether frame format data to the L2/L3 switch, and based on the input frames from the Port2, the MAC learning table-L2/L3 switch of the L2/L3 switch stores MAC address=c, VID=100, and Port=2. In the transmitted signals from the terminal B to the terminal C, based on the ether frame format data that is output from the terminal B, the RPR card Y (p) stores MAC address=b, VID=100, and Direction=ingress in the MAC learning table Y (p). Learning of the aforementioned MAC addresses enables to smoothly secure a new transmission path between the RPR card Y (p) and the L2/L3 switch after switching.

In the aforementioned embodiment, the detection of disconnection of the communication link between the physical interface PHY 132 and the Port1 201a acts as a trigger to switch the RPR cards from the RPR card Y (w) to the RPR card Y (p). However, the present invention is not to be thus limited, and a failure in the RPR card Y (w) (a partial defect in the functional blocks etc.) or receipt of a command from an external device can also be used as a trigger to execute the switching process.

According to the aforementioned embodiment, a dual redundant structure of the RPR cards is included without modifying a connecting interface with the RPR ring network and a connecting interface with the L2/L3 switch that are used in the conventional RPR connecting method, thereby enabling to provide the ring node device such that if a failure occurs in the communication link between one of the RPR cards and the terminal, the other queued RPR card is smoothly substituted in operation by switching and functions alternatively. Further, the main RPR interface card and the queued RPR interface card included in the redundant structure of the ring node device are allocated the same ID as the station ID (MAC address of the ring node device in the present embodiment) that is an identifier of the RPR ring node device. Thus, the other ring node devices do not recognize the redundant structure, thereby enabling to treat the main RPR interface card and the queued RPR interface card as a single ring node device instead of treating the main RPR interface card and the queued RPR interface card as separate ring node devices.

During occurrence of a failure in the communication link between one of the RPR cards and the terminal, deleting the learned MAC address and relearning the MAC address enable to exercise control to modify path data of the entire RPR ring network by using a simple method without necessitating a complex protocol.

The ring node device includes the RPR card redundant structure that can secure a communication line (transmission path) even during occurrence of a failure, thereby enabling to provide the ring node device that enables detachment of maintenance units and simultaneously enables functions of the RPR stations.

Thus, a ring node device can be provided in the RPR ring network based on the SONET/SDH such that even if a communication failure occurs in the periphery (a communication link portion between the RPR stations or the terminals) of the RPR cards inside the ring node device, the RPR ring network communication of the terminals under the ring node device affected by the failure is not disconnected.

The redundant structure of the RPR cards can be provided by using a method based only on MAC filtering without necessitating complex protocols and processes such as the OAM frames for modifying the path data of the entire RPR ring network.

The present invention in its broader aspects is not limited to the specific details and representative embodiments shown and described herein. Accordingly, various modifications may be made without departing from the spirit or scope of the general inventive concept as defined by the appended claims and their equivalents. Further, the effects described in the embodiments are not to be thus limited.

According to the present invention, a ring network includes a ring node device that uses a main RPR interface card and a queued RPR interface card for connecting a terminal to the RPR ring network. Both the RPR interface cards are allocated the same identifier, and although signals are input from the ring network into both the main RPR interface card and the queued RPR interface card, signal output from the queued RPR interface card to the terminal is terminated, and input signals from the terminal into the queued RPR interface card are masked, thereby enabling to select and use the main RPR interface card. Thus, during occurrence of a failure in the main RPR interface card, the queued RPR interface card can be equivalently used as the main RPR interface card, thereby enabling to carry out a smooth switching of the RPR interface cards.

According to the present invention, a redundant structure uses the main RPR interface card and the queued RPR interface card for connecting the terminal to the RPR ring network. Although signals are input from the ring network into both the main RPR interface card and the queued RPR interface card, signal output from the queued RPR interface card to the terminal is terminated, and input signals from the terminal into the queued RPR interface card are masked, thereby enabling to select and use the main RPR interface card.

According to the present invention, upon notification of a disconnection of a communication link between the main RPR interface card and the terminal, output of input signals that are input into the queued RPR interface card to the terminal is started, and signals that are input into the queued RPR interface card from the terminal are unmasked, thereby enabling to carry out a smooth switching from the main RPR interface card to the queued RPR interface card and enabling a speedy failure recovery.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A ring node device included in a ring network, the ring node device allocated with an identifier for identifying the ring node device from other devices on the ring network, the ring node device comprising:
a first connecting unit and a second connecting unit, the first connecting unit and the second connecting unit employing Resilient Packet Ring (RPR) technique, the first connecting unit and the second connecting unit being allocated with same identifier as that of the ring node device, the first connecting unit and the second connecting unit being input with a first signal from the ring network for sending the first signal to a terminal and input with a second signal from the terminal for sending the second signal to the ring network;
a second controlling unit that controls the second connecting unit so that the second connecting unit does not output the first signal to the terminal; and
a second masking unit that masks the second signal before the second signal is input into the second connecting unit.

2. The ring node device according to claim 1, wherein
the second controlling unit controls the second connecting unit so that the second connecting unit does not output the second signal to the ring network.

3. The ring node device according to claim 1, further comprising a detecting unit that detects disconnection of communication link between the first connecting unit and the terminal, wherein
upon the detecting unit detecting the disconnection, the second controlling unit controls the second connecting unit so that the second connecting unit outputs the first signal to the terminal, and the second masking unit unmasks the second signal.

4. The ring node device according to claim 3, further comprising:
a first controlling unit that controls the first connecting unit, upon the detecting unit detecting the disconnection, so that the first connecting unit does not output the first signal to the terminal; and
a second masking unit that masks, upon the detecting unit detecting the disconnection, the second signal before the second signal is input into the first connecting unit.

5. The ring node device according to claim 2, wherein the second controlling unit includes a selecting unit that selects whether the second signal output from the first connecting unit be output to the ring network or the second signal output from the second connecting unit be output to the ring network.

6. The ring node device according to claim 1, wherein
the RPR ring network includes a first ring network and a second ring network such that a signal transmission direction of the second ring network is in opposite direction of a signal transmission direction of the first ring network,
the first connecting unit and the second connecting unit being input with first signals from both the first ring network and the second ring network,
the ring node device further comprising a selecting unit that selectively outputs the second signal output from the first connecting unit and the second connecting unit to any one of the first ring network and the second ring network.

7. The ring node device according to claim 3, further comprising:
a first storage unit that configured to store therein identifiers of the terminal and a transmission terminal in the RPR ring network that transmits the first signal to the terminal when the first signal passes via the first connecting unit; and
a second storage unit configured to store therein identifiers of the terminal and a transmission terminal in the RPR ring network that transmits the first signal to the terminal when the first signal passes through the second connecting unit; and
a deleting unit that deletes from the first storage unit the identifier of the terminal upon the detecting unit detecting the disconnection.

8. The ring node device according to claim 7, wherein the second storage unit stores therein the identifier of the receiving terminal upon the masking unit unmasking the second signal.

9. The ring node device according to claim 1, further comprising:
a first storage unit that stores therein information about a transmission path in the RPR ring network of the first signal that passes via the first connecting unit; and
a second storage unit that stores therein information about a transmission path in the RPR ring network of the first signal that passes via the second connecting unit,
wherein the same transmission path is stored in the first storage unit and the second storage unit regardless of whether the second controlling unit controls the second connecting unit and whether the second masking unit masks the second signal.

10. A method of connecting a terminal device to a ring node device included in a ring network, the ring node device allocated with an identifier for identifying the ring node device from other devices on the ring network, the ring node device including a first connecting unit and a second connecting unit, the first connecting unit and the second connecting employing Resilient Packet Ring (RPR) technique, the first connecting unit and the second connecting unit being allocated with the same identifier as that of the ring node device, the method comprising:
inputting a first signal received via the ring network to both the first connecting unit and the second connecting unit for sending the first signal to the terminal;
controlling the second connecting unit so that the first signal is not output to the terminal;
masking a second signal received from the terminal before the second signal is input into the second connecting unit; and
outputting the second signal output from any one of the first connecting unit and the second connecting unit to the ring network.

11. The method according to claim 10, wherein
the controlling includes controlling the second connecting unit so that the second connecting unit does not output the second signal to the ring network.

12. The method according to claim 10, further comprising detecting disconnection of communication link between the first connecting unit and the terminal, wherein, upon detecting the disconnection at the detecting,
the controlling includes controlling the second connecting unit so that the second connecting unit outputs the first signal to the terminal, and
the masking includes unmasking the second signal.

13. The method according to claim 12, further comprising:
controlling the first connecting unit, upon detecting the disconnection at the detecting, so that the first connecting unit does not output the first signal to the terminal; and
masking, upon detecting the disconnection at the detecting, the second signal before the second signal is input into the first connecting unit.

14. The method according to claim 11, wherein the controlling unit includes selecting the second signal from the first connecting unit for outputting to the ring network or the second signal output from the second connecting unit for outputting to the ring network.

15. The method according to claim 10, wherein
the RPR ring network includes a first ring network and a second ring network such that a signal transmission direction of the second ring network is in opposite direction of a signal transmission direction of the first ring network,
the inputting includes inputting first signals from both the first ring network and the second ring network to both first connecting unit and the second connecting unit,
the method further comprising selecting any one of the second signal output from the first connecting unit and the second connecting unit for outputting to any one of the first ring network and the second ring network.

16. The method according to claim 12, further comprising:
storing in a first storage unit identifiers of the terminal and a transmission terminal in the RPR ring network that transmits the first signal to the terminal when the first signal passes via the first connecting unit, storing in a second storage unit identifiers of the terminal and a transmission terminal in the RPR ring network that transmits the first signal to the terminal when the first signal passes through the second connecting unit; and
deleting from the first storage unit the identifier of the terminal upon detecting the disconnection at the detecting.

17. The method according to claim 16, wherein the storing includes storing in the second storage unit the identifier of the receiving terminal upon the second signal is unmasked at the masking.

18. The method according to claim 10, further comprising:
storing in a first storage unit information about a transmission path in the RPR ring network of the first signal that passes via the first connecting unit; and
storing in a second storage unit information about a transmission path in the RPR ring network of the first signal that passes via the second connecting unit,
wherein storing includes storing the same transmission path in the first storage unit and the second storage unit regardless of whether the controlling controls the second connecting unit and whether the masking masks the second signal.
